(19) United States
(12) Patent Application Publication
(10) Pub. No.: US 2014/0354221 A1
(43) Pub. Date: Dec. 4, 2014

(54) ANTENNA ARRANGEMENT FOR POCKET-FORMING

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 13/908,839

(22) Filed: Jun. 3, 2013

(51) Int. Cl. H02J 7/02; H01F 38/14

(52) U.S. Cl. CPC H02J 7/025; H01F 38/14
USPC 320/108; 307/104

(57) ABSTRACT

The present disclosure describes a plurality of antenna arrangements that may be suitable for wireless power transmission based on single or multiple pocket-forming. Single or multiple pocket-forming may include one transmitter and at least one or more receivers, being the transmitter the source of energy and the receiver the device that is desired to charge or power. The antenna arrangements may vary in size and geometry, and may operate as a single array, pair array, quad arrays or any other suitable arrangement, which may be designed in accordance with the desired application.

### CROSS-REFERENCES TO RELATED APPLICATIONS

This application claims priority to U.S. Non-Provisional patent application Ser. No. 13/891,399 filed May 10, 2013, entitled “Receivers For Wireless Power Transmission”; Ser. No. 13/891,430 filed May 10, 2013, entitled “Methodology For Pocket forming” and Ser. No. 13/1891,455 filed May 10, 2013, entitled “Transmitters For Wireless Power Transmission”, the entire contents of which are incorporated herein by these references.

### FIELD OF INVENTION

The present disclosure relates to wireless power transmission, and more particularly to the antenna arrangements for wireless power transmission based on pocket-forming.

### BACKGROUND OF THE INVENTION

Portable electronic devices such as smart phones, tablets, notebooks and others, have become an everyday need in the way we communicate and interact with others. The frequent use of these devices may require a significant amount of power, which may easily deplete the batteries attached to these devices. Therefore, a user is frequently needed to plug in the device to a power source, and recharge such device. This may be inconvenient and troublesome if the user forgets to plug in or otherwise charge a device, the device may run out of power and be of no use to the user until the user is again able to charge the device.

There are many approaches in the literature that have tried to reduce the impact of the changing needs of portable electronic devices. In some cases the devices have rechargeable batteries. However, the aforementioned approach requires a user to carry around extra batteries, and also make sure that the extra set of batteries is charged. Solar-powered battery chargers are also known, however, solar cells are expensive, and a large array of solar cells may be required to charge a battery of any significant capacity. Other approaches involve a mat or pad that allows to charge a device without physically connecting a plug of the device, by using electromagnetic signals. In this case, the device still requires to be placed in a certain location for a period of time in order to be charged. Assuming a single source power transmission of electro-magnetic, (EM) signal, an EM signal gets reduced by a factor of 1/r² in magnitude over a distance r. Thus, the received power at a large distance from the EM transmitter is a small fraction of the power transmitted.

To increase the power of the received signal, the transmission power would have to be boosted. Assuming that the transmitted signal has an efficient reception at three centimeters from the EM transmitter, receiving the same signal power over a useful distance of three meters would entail boosting the transmitted power by 10,000×. Such power transmission is wasteful, as most of the energy would be transmitted and not received by the intended devices, it could be hazardous to living tissue, it would most likely interfere with most electronic devices in the immediate vicinity, and it may be dissipated as heat.

In yet another approach such as directional power transmission, it would generally require knowing the location of the device to be able to point the signal in the right direction to enhance the power transmission efficiency. However, even when the device is located, efficient transmission is not guaranteed due to reflections and interference of objects in the path or vicinity of the receiving device.

Therefore, a wireless power transmission method solving the aforementioned problems is desired.

### SUMMARY OF THE INVENTION

The present disclosure provides a plurality of antenna arrangements that may be suitable for the formation of a single or multiple pockets of energy onto one or more devices. Pockets of energy may be formed by using at least one transmitter and one or more receivers. In one or more aspects of the present disclosure, the transmitter may include a housing having at least two antenna elements, at least one radio frequency integrated circuit (RTIC), and at least one digital signal processor or micro-controller which may be connected to a power source. The housing may also include a communications component.

In another aspect of the present disclosure, the transmitter may include a flat panel antenna array having a N number of antenna elements; where gain requirements for power transmitting may be from 64 to 256 antenna elements being distributed in an equally spaced grid. However, the number and type of antenna elements may vary in relation with the desired range and power transmission capability on transmitter, the more antenna elements, the wider range and higher power transmission capability. Suitable antenna elements may be flat antennas, patch antennas, and dipole antennas among others. Alternate configurations may also be possible including circular patterns or polygon arrangements.

In yet another aspect of the present disclosure, the antenna elements may operate in single array, pair array, quad array and any other suitable arrangement, which may be designed in accordance with the desired application. In one embodiment, a single array may operate only in one frequency band such as 5.8 GHz. In another embodiment, a pair array may be divided so as to use ½ of the antenna elements to operate at one frequency and the other ½ to operate at another frequency. These frequencies may alternate one another among 900 MHz, 2.4 Ghz, and 5.8 Ghz, as these frequency bands may comply with the FCC regulations, part 18, yet another embodiment, a quad array may have 4 antenna elements. In the quad array, each antenna element may be virtually divided in two or more patches to operate at different frequencies. By virtually dividing the antenna elements, power losses during wireless power transmission may be avoided.

The different antenna arrangements described in the present disclosure may improve the capability and efficiency of the transmitter to provide wireless power transmission to one or more devices that may operate at different frequency bands

These and other advantages of the present disclosure may be evident to those skilled in the art, or may become evident upon reading the detailed description of the prefer embodiment, as shown in the accompanying drawings.

### BRIEF DESCRIPTION OF THE DRAWINGS

Embodiments of the present disclosure are described by way of example with reference to the accompanying figures, which are schematic and may not be drawn to scale. Unless indicated as representing prior art, the figures represent aspects of the present disclosure. The main features and advantages of the present disclosure will be better understood with the following descriptions, claims, and drawings, where:

FIG. 1 illustrates a wireless power transmission example situation using pocket-forming.

FIG. 2 illustrates a component level embodiment for a transmitter.

FIG. 3 is an exemplary illustration of a flat panel antenna array that may be used in a transmitter, as the one described in FIG. 2.

FIG. 4 shows antenna arrays, according to various embodiments.

### DETAILED DESCRIPTION OF THE DRAWINGS

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy thr powering, or charging an electronic device.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

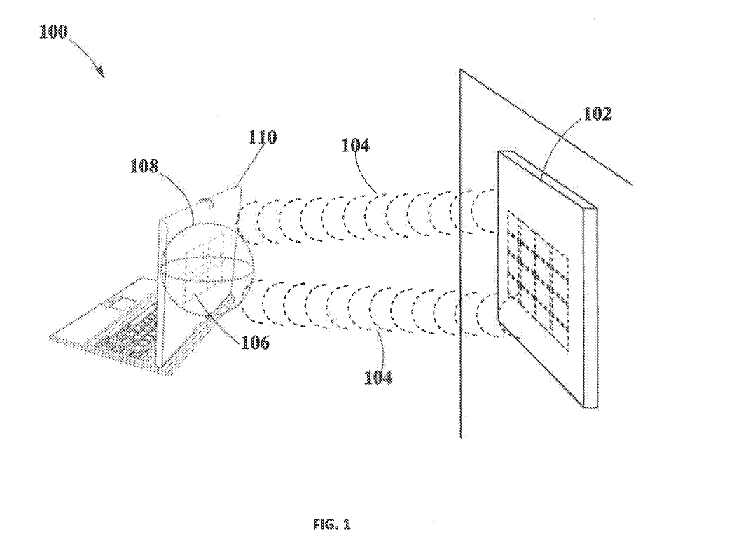

FIG. 1 illustrates wireless power transmission 100 using pocket-forming. A transmitter 102 may transmit controlled Radio RF waves 104 which may converge in 3-d space. These Radio frequencies (RF) waves 104 may be controlled through phase and/or relative amplitude adjustments to form constructive and destructive interference patterns (pocket-forming). Pockets of energy 108 may be formed at constructive interference patterns and can be 3-dimensional in shape whereas null-spaces may be generated at destructive interference patterns. A receiver 106 may then utilize pockets of energy 108 produced by pocket-forming for charging or powering an electronic device, for example a laptop computer 110 and thus effectively providing wireless power transmission. In other situations there can be multiple transmitters 102 and/or multiple receivers 106 for powering various electronic equipment for example smartphones, tablets, music players, toys and others at the same time. In other embodiments, adaptive pocket-forming may be used to regulate power on electronic devices.

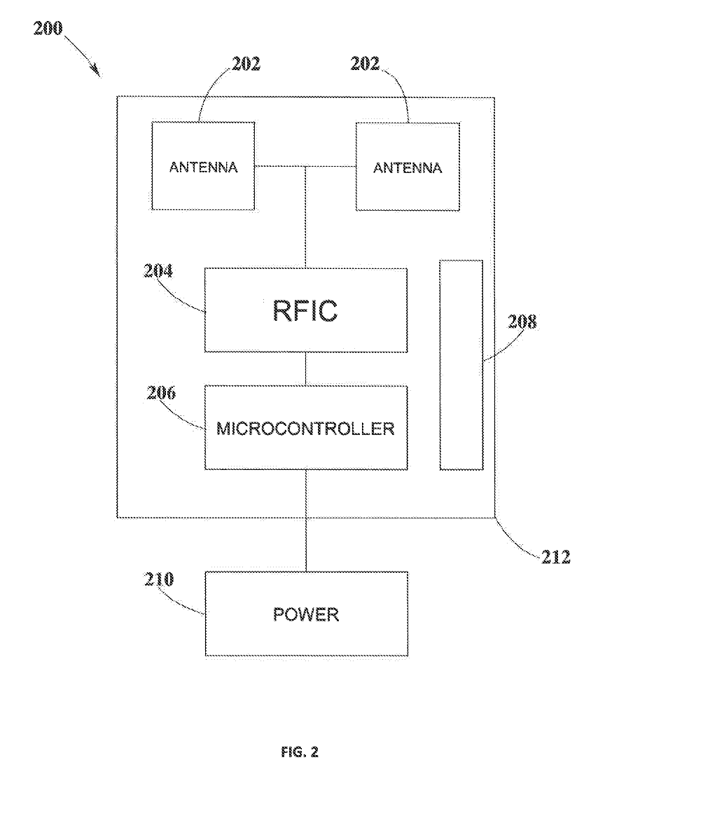

FIG. 2 depicts a basic block diagram of a transmitter 200 which may be utilized for wireless power transmission 100. Such transmitter 200 may include one or more antenna elements 202, one or more Radio frequency integrated circuit (RFIC) 204, one or more microcontroller 206, a communication component 208, a power source 210 and a housing 212, which may allocate all the requested components for transmitter 200. Components in transmitter 200 may be manufactured using meta-materials, micro-printing of circuits, nano-materials, and the like.

Transmitter 200 may be responsible for the pocket-forming, adaptive pocket-forming and multiple pocket-forming through the use of the components mentioned in the foregoing paragraph. Transmitter 200 may send wireless power transmission to one or more receivers in form of radio signals, such signals may include any radio signal with any frequency or wavelength.

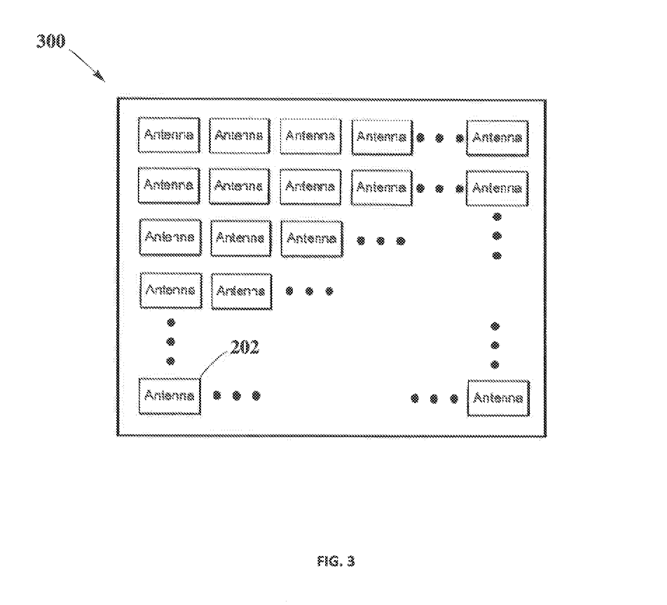

FIG. 3 is an exemplary illustration of a that panel antenna array 300 that may be used in transmitter 200, described in FIG. 2. Flat panel antenna array 300 may then include an N number of antenna elements 202 where gain requirements for power transmitting may be from 64 to 256 antenna elements 202 which may be distributed in an equally spaced grid. In one embodiment, flat panel antenna array 300 may have a 8×8 grid to have a total of 64 antenna elements 202. In another embodiment, flat panel antenna array 300 may have a 16×16 grid to have a total of 256 antenna elements 202. However, the number of antenna elements 202 may vary in relation with the desired range and power transmission capability on transmitter 200, the more antenna elements 202, the wider range and higher power transmission capability. Alternate configurations may also be possible including circular patterns or polygon arrangements.

Flat panel antenna array 300 may also be broken into numerous pieces and distributed across multiple surfaces (multi-faceted).

Antenna elements 202 may include flat antenna elements 202, patch antenna elements 202, dipole antenna elements 202 and any suitable antenna for wireless power transmission. Suitable antenna types may include, for example, patch antennas with heights from about ½ inch to about 6 inches and widths from about ½ inch to about 6 inches. Shape and orientation of antenna elements 202 may vary in dependency of the desired features of transmitter 200, orientation may be flat in X, Y, and Z axis, as well as various orientation types and combinations in three dimensional arrangements. Antenna elements 202 materials may include any suitable material that may allow radio signal transmission with high efficiency, good heat dissipation and the like.

Antenna elements 202 may include suitable antenna types for operating in frequency bands such as 900 MHz, 2.5 GHz, or 5.8 GHz as these frequency bands conform to Federal Communications Commission (FCC) regulations part 18 (Industrial, Scientific and Medical equipment). Antenna elements 202 may operate in independent frequencies, allowing a multichannel operation of pocket-forming.

In addition, antenna elements 202 may have at least one polarization or a selection of polarizations. Such polarization may include vertical pole, horizontal pole, circularly polarized, left hand polarized, right hand polarized, or a combination of polarizations. The selection of polarizations may vary in dependency of transmitter 200 characteristics. In addition, antenna elements 202 may be located in various surfaces of transmitter 200.

Antenna elements 202 may operate in single array, pair array, quad array and any other suitable arrangement, which may be designed in accordance with the desired application.

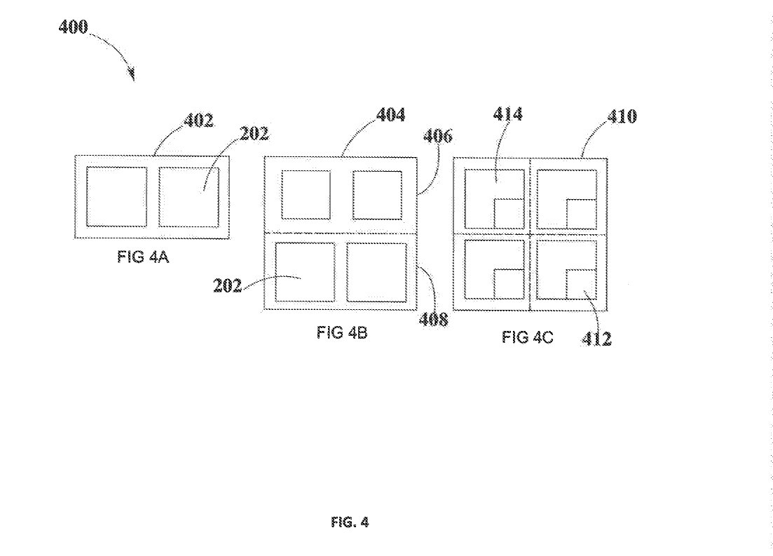

FIG. 4 shows antenna arrays 400 according to various embodiments. Antenna arrays 400 may include suitable antenna types for operating in frequency bands such as 900 MHz, 2.5 GHz, and 5.8 GHz, as these frequency bands may comply with the FCC regulations, part 18.

FIG. 4A shows a single array 402 where all antenna elements 202 may operate at 5.8 Ghz. Thus single array 402 may be used for charging or powering a single device, similar to the embodiment described in FIG. 1. FIG. 4B shows pair array 404, where the top half 406 of antenna elements 202 may operate at 5.8 Ghz and the bottom half 408 may operate at 2.4 Ghz. Pair array 404 may then be used to charge or power, at the same time, two receivers 106 that may operate at different frequency hands such as the ones described above. As seen in FIG. 4B, antenna elements 202 may vary in size according to the antenna type.

FIG. 4C shows a quad array 410 where each antenna element 202 may be virtually divided to avoid power losses during wireless power transmission. In this embodiment, each antenna element 202 may be virtually divided in two antenna elements 202, antenna element 412 and antenna element 414. Antenna element 412 may be used for transmitting in 5.8 GHz frequency band and antenna element 414 may be used for transmitting in 2.4 GHz frequency band. Quad array 410 may then be used in situations where multiple receivers 106 operating at different frequency bands require to be charged or powered.

### EXAMPLES

In example #1 a portable electronic device that may operate at 2.4 GHz may be powered or charged. In this example, a transmitter as the one described in FIG. 2, may be used to deliver pockets of energy onto one electronic device, as in FIG. 1. This transmitter may have a single array of 8×8 of flat panel antennas where all the antenna elements may operate in the frequency hand of 2.4 GHz. Flat antennas may occupy less volume than other antennas, hence allowing a transmitter to be located at small and thin spaces, such as, walls, mirrors, doors, ceilings and the like. In addition, flat panel antennas may be optimized for operating to long distances into narrow hall of wireless power transmission, such feature may allow operation of portable devices in long areas such as, train stations, bus stations, airports and the like. Furthermore, flat panel antennas of 8×8 may generate smaller pockets of energy than other antennas since its smaller volume, this may reduce losses and may allow more accurate generation of pockets of energy, such accuracy may be employed for charging/powering a variety of portable electronic devices near areas and/or objects which do not require pockets of energy near or over them.

In example #2 two electronic devices that may operate at two different frequency bands may be powered or charged at the same time. In this example, the transmitter as the one described in FIG. 2, may be used to deliver pockets of energy onto two electronic devices. In this example, the transmitter may have a pair array with different type of antennas, flat panel antennas and dipole antennas, where ½ of the array may be formed by flat panel antennas and the other half by dipole antennas, as shown in FIG. 4b. As described in example #1, flat panel antennas may be optimized to radiate power within narrow halls at considerable distances. On the other hand, dipole antennas may be employed for radiating power at nearer distances but covering more area because of their radiation pattern. Furthermore, dipole antennas may be manually adjusted, this feature may be beneficial when the transmitter is located at crowded spaces and transmission needs to be optimized.

Having thus described the invention, we claim:

1. A method for transmitting wireless power, comprising:
generating two or more RF waves from a transmitter with at least two RF transmit antennas;
forming controlled constructive and destructive interference patterns from the generated RF waves by a radio frequency integrated circuit controlled by a microcontroller;
accumulating energy or power in the form of constructive interference patterns from the RF waves to form pockets of energy;
converging the pockets of energy in 3-d space to a targeted electronic device;
arranging the antennas in an array optimal for charging or operating the targeted electronic device with the pockets of energy.

2. The method for transmitting wireless power of claim 1, further the method of forming controlled destructive interference patterns from the generated RF waves and accumulating energy or power in the form of destructive interference patterns from the RF waves to form null-spaces of energy and including a plurality of antenna array arrangements suitable for the formation of a single or multiple pockets of energy transmitted to one or more targeted electronic devices.

3. The method for transmitting wireless power of claim 1, further including a flat panel antenna array having a N number of antennas where gain requirements for power transmitting range from 64 to 256 antennas distributed in an equally spaced grid for enhancing reception of the pockets of energy by the electronic device.

4. The method for transmitting wireless power of claim 3, wherein the number and type of antennas varies in relationship to a predetermined desired range and power transmission capability of the transmitter whereby the greater the N number of antennas results in a wider range and a higher power delivery of pockets of energy to the targeted electronic device.

5. The method for transmitting wireless power of claim 1, wherein the antennas are flat antennas, patch antennas, dipole antennas or any other antennas configured for transmission of pockets of energy.

6. A system for transmitting wireless power, comprising:
a transmitter having two RF antennas in an array for generating pockets of energy;
a receiver electrically connected to at least one electronic device for receiving the pockets of energy;
a micro-controller connected to a power source for controlling the generated pockets of energy delivered to the electronic device from a predetermined array of antennas.

7. The system for transmitting wireless power of claim 6, wherein the transmitter generating two or more RF waves from at least two RF transmit antennas creates constructive interference patterns from the RF waves to form predetermined pockets of energy under the direction of the micro-controller.

8. The system for transmitting wireless power of claim 6, wherein the receiver includes at least one antenna for receiving the pockets of energy for charging or operating the electronic device.

9. The system for transmitting wireless power of claim 8, wherein the generated pockets of energy are received by a plurality of electronic devices at a higher efficiency due to antenna array orientation on the transmitter and receiver directed by the micro-controller in response to a communication signal from the receiver.

10. The system for transmitting wireless power of claim 6, further including a radio frequency integrated circuit driven by a predetermined program in the micro-controller for pocket-forming to charge or operate the electronic device through an antenna array including a N number of antenna elements in the range of 64 to 256 antenna elements distributed in an equally spaced grid on the transmitter.

11. A system for transmitting wireless power, comprising:
a transmitter for generating two or more RF waves having at least two RF transmit antennas to form controlled constructive interference patterns from the generated RF waves;
a micro-controller within the transmitter controlling the constructive interference patterns of generated RF waves for pocket-forming to accumulate pockets of energy in predetermined areas or regions in space;
a receiver with at least one antenna to receive the accumulated pockets of energy converging in 3-d space to a targeted electronic device;
a communication network connected to transmitter and receiver for determining the areas or regions in space to receive the pockets of energy from the transmitter through an array of antennas for charging or operating the targeted electronic device.

12. The system for transmitting wireless power of claim 11, wherein the transmitter generates RF waves to form controlled destructive interference patterns that form null-spaces without pockets of energy, and wherein the array of antennas is a 8×8 grid having a total of 64 antenna elements distributed in an equally spaced grid.

13. The system for transmitting wireless power of claim 11, wherein the array of antennas is a 16×16 having a total of 256 antenna elements distributed in an equally spaced grid.

14. The system for transmitting wireless power of claim 11, wherein the number of antennas varies depending upon the predetermined range and power transmission.

15. The system for transmitting wireless power of claim 11, wherein the antennas arrangement includes circular patterns or polygon configurations for charging or operating a plurality of electronic devices.

16. The system for transmitting wireless power of claim 11, wherein the antennas operate in frequency bands of 900 MHz, 2.5 GHz or 5.8 GHz bands.

17. The system for transmitting wireless power of claim 11, wherein the antennas have at least one polarization or a polarization including a vertical pole, horizontal pole, circularly polarized, left hand polarized, right hand polarized or a combination of polarizations.

18. The system for transmitting wireless power of claim 11, wherein the antennas operate in a single array, pair array, quad array or any other suitable array arrangement for transmission of pockets of energy.

19. The system for transmitting wireless power of claim 11, wherein the antennas are arranged in a pair array where the top half of the antennas operate a 5.8 GHz and the bottom half of the array operates at 2.4 GHz driven by the transmitter controlled by the micro-controller.

20. The system for transmitting wireless power of claim 11, wherein the micro-controller dynamically adjusts the pocket-forming through a predetermined antenna array to regulate power on one or more targeted electronic devices.
